(19) United States
(12) Patent Application Publication
(10) Pub. No.: US 2025/0225530 A1
(43) Pub. Date: Jul. 10, 2025

(54) METHOD FOR PROVIDING SALES AND CUSTOMER SERVICES

(71) Applicant: BitHuman Inc, Lafayette, CA (US)

(72) Inventors: Steve Gu, Lafayette, CA (US); Yun Fu, Newton, MA (US)

(73) Assignee: BitHuman Inc, Lafayette, CA (US)

(21) Appl. No.: 18/407,448

(22) Filed: Jan. 9, 2024

(51) Int. Cl. G06Q 30/015; G06F 3/01; G06Q 10/083; G06Q 30/0601; H04R 1/40

(52) U.S. Cl. CPC G06Q 30/015; G06Q 10/083; G06Q 30/0621; G06Q 30/0631; G06F 3/012; G06F 3/013; H04R 1/406

(57) ABSTRACT

Embodiments of the present disclosure may include a method for providing sales and customer services via virtual agents powered with artificial intelligence, the method including detecting, by one or more processors, a request from a user in a store.

### BACKGROUND OF THE INVENTION

Embodiments of the present disclosure may include a method for providing sales and customer services via virtual agents powered with artificial intelligence, the method including detecting, by one or more processors, a request from a user in a store.

### BRIEF SUMMARY

Embodiments of the present disclosure may include a method for providing sales and customer services via virtual agents powered with artificial intelligence, the method including detecting, by one or more processors, a request from a user in a store. In some embodiments, an artificial intelligence engine may be coupled to the one or more processors and a server.

In some embodiments, the artificial intelligence engine may be trained by human experts in the field. In some embodiments, the virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agents.

In some embodiments, the virtual agents may be configured to be displayed with an appearance of a real human or a humanoid or a cartoon character. In some embodiments, the virtual agents' gender, age and ethnicity may be determined by the artificial Intelligence's analysis on input from the user. In some embodiments, the virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

In some embodiments, the visual agents may be connected via network means. Embodiments may also include detecting and tracking the user's face, eye, and pose by a set of outward-facing cameras coupled to the one or more processors. In some embodiments, a set of touch screens coupled to the one or more processors may be configured to allow the user to interact with the virtual agents by hand, facial express, sign language and body posture.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual agents.

In some embodiments, the virtual agents may be configured to be created based on the appearance of a real human character. Embodiments may also include analyzing the user's profile from audio-visual information gathered by the set of outward-facing cameras and the set of microphones. In some embodiments, the user's profile includes the user's audio and facial characteristics.

Embodiments may also include selecting the user's profile based on matching audio and facial characteristics from a set of profiles in a customer database on the server. In some embodiments, the user's profile may include information on prior food ordering habits, food preferences, and possible food allergies. Embodiments may also include guiding and suggesting a set of items through conversation between the virtual agents and the user.

In some embodiments, the guiding and the suggestions may be based on the user's profile and analysis of the artificial intelligence engine. In some embodiments, the virtual agent may be configured to suggest items that the user may be mostly willing to buy based on interactions between the virtual agents and the user and the analysis of the artificial intelligence engine.

Embodiments may also include providing options for the user to customize and make orders of any of items in the store. In some embodiments, the options may include customization of the items, methods of payment or financing, and method of delivery of the items. Embodiments may also include receiving information of orders of any of the items from the user.

In some embodiments, the information includes information of payment. In some embodiments, the user can choose different ways for the payment. In some embodiments, the different ways includes usages of credit cards, payment applications, cash, checks, cryptocurrency or other payment means. Embodiments may also include transmitting the orders to cloud servers of the store. Embodiments may also include arranging the orders to be delivered to an address. In some embodiments, the address may be chosen by the user. Embodiments may also include adding the orders and payment information to the user's profile.

Embodiments of the present disclosure may also include a method for providing sales and customer services via virtual agents powered with artificial intelligence, the method including detecting, by one or more processors, a request from a user in a store. In some embodiments, an artificial intelligence engine may be coupled to the one or more processors and a server.

In some embodiments, the artificial intelligence engine may be trained by human experts in the field. In some embodiments, the virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agents.

In some embodiments, the virtual agents may be configured to be displayed with an appearance of a real human or a humanoid or a cartoon character. In some embodiments, the virtual agents' gender, age and ethnicity may be determined by the artificial Intelligence's analysis on input from the user. In some embodiments, the virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

In some embodiments, the visual agents may be connected via network means. Embodiments may also include detecting and tracking the user's face, eye, and pose by a set of outward-facing cameras coupled to the one or more processors. In some embodiments, a set of touch screens coupled to the one or more processors may be configured to allow the user to interact with the virtual agents by hand, facial express, sign language and body posture.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual agents.

In some embodiments, the virtual agents may be configured to be created based on the appearance of a real human character. Embodiments may also include analyzing the user's profile from audio-visual information gathered by the set of outward-facing cameras and the set of microphones. In some embodiments, the user's profile includes the user's audio and facial characteristics.

Embodiments may also include selecting the user's profile based on matching audio and facial characteristics from a set of profiles in a customer database on the server. In some embodiments, the user's profile may include information on prior food ordering habits, food preferences, and possible food allergies. Embodiments may also include guiding and suggesting a set of items through conversation between the virtual agents and the user.

In some embodiments, the guiding and the suggestions may be based on the user's profile and analysis of the artificial intelligence engine. In some embodiments, the virtual agent may be configured to suggest items that the user may be mostly willing to buy based on interactions between the virtual agents and the user and the analysis of the artificial intelligence engine.

Embodiments may also include providing options for the user to customize and make orders of any of items in the store. In some embodiments, the options may include customization of the items, methods of payment or financing, and method of delivery of the items. Embodiments may also include receiving information of orders of any of the items from the user.

In some embodiments, the information includes information of payment. In some embodiments, the user can choose different ways for the payment. In some embodiments, the different ways include usages of credit cards, payment applications, cash, checks, cryptocurrency or other payment means. In some embodiments, the user also can scan a QR code for certain items for ordering and payment.

Embodiments may also include transmitting the orders to cloud servers of the store. Embodiments may also include arranging the orders to be delivered to an address. In some embodiments, the address may be chosen by the user. Embodiments may also include adding the orders and payment information to the user's profile.

Embodiments of the present disclosure may also include a method for providing sales and customer services via virtual agents powered with artificial intelligence, the method including detecting, by one or more processors, a request from a user in a store. In some embodiments, an artificial intelligence engine may be coupled to the one or more processors and a server.

In some embodiments, the artificial intelligence engine may be trained by human experts in the field. In some embodiments, the virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agents.

In some embodiments, the virtual agents may be configured to be displayed with an appearance of a real human or a humanoid or a cartoon character. In some embodiments, the virtual agents' gender, age and ethnicity may be determined by the artificial Intelligence's analysis on input from the user. In some embodiments, the virtual agents may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

In some embodiments, the visual agents may be connected via network means. Embodiments may also include detecting and tracking the user's face, eye, and pose by a set of outward-facing cameras coupled to the one or more processors. In some embodiments, a set of touch screens coupled to the one or more processors may be configured to allow the user to interact with the virtual agents by hand, facial express, sign language and body posture.

In some embodiments, the user can be identified by a specific facial ID. Embodiments may also include detecting the user's voice by a set of microphones coupled to the one or more processors. In some embodiments, the set of microphones may be connected to loudspeakers. In some embodiments, the set of microphones may be enabled to be beamforming.

In some embodiments, pictures or voices of the user may be configured to be uploaded and processed either on a cloud server or in local or personal devices to analyze and create the virtual agents. In some embodiments, the virtual agents may be configured to be created based on the appearance of a real human character. Embodiments may also include analyzing the user's profile from audio-visual information gathered by the set of outward-facing cameras and the set of microphones.

In some embodiments, the user's profile includes the user's audio and facial characteristics. In some embodiments, the user's facial ID may be associated with the facial characteristics. Embodiments may also include selecting the user's profile based on matching audio and facial characteristics from a set of profiles in a customer database on the server.

In some embodiments, the user's profile may include information on prior food ordering habits, food preferences, and possible food allergies. Embodiments may also include guiding and suggesting a set of items through conversation between the virtual agents and the user. In some embodiments, the guiding and the suggestions may be based on the user's profile and analysis of the artificial intelligence engine.

In some embodiments, the virtual agent may be configured to suggest items that the user may be mostly willing to buy based on interactions between the virtual agents and the user and the analysis of the artificial intelligence engine. Embodiments may also include providing options for the user to customize and make orders of any of items in the store.

In some embodiments, the options may include customization of the items, methods of payment or financing, and method of delivery of the items. Embodiments may also include receiving information of orders of any of the items from the user. In some embodiments, the information includes information of payment.

In some embodiments, the user can choose different ways for the payment. In some embodiments, the different ways include usages of credit cards, payment applications, cash, checks, cryptocurrency or other payment means. In some embodiments, the user also can scan a QR code for a certain items for ordering and payment. Embodiments may also include transmitting the orders to cloud servers of the store. Embodiments may also include arranging the orders to be delivered to an address. In some embodiments, the address may be chosen by the user. Embodiments may also include adding the orders and payment information to the user's profile.

### BRIEF DESCRIPTION OF THE FIGURES

FIG. 1A is a flowchart illustrating a method for providing sales and customer services, according to some embodiments of the present disclosure.

FIG. 1B is a flowchart extending from FIG. 1A and further illustrating the method for providing sales and customer services, according to some embodiments of the present disclosure.

FIG. 2A is a flowchart illustrating a method for providing sales and customer services, according to some embodiments of the present disclosure.

FIG. 2B is a flowchart extending from FIG. 2A and further illustrating the method for providing sales and customer services, according to some embodiments of the present disclosure.

FIG. 3A is a flowchart illustrating a method for providing sales and customer services, according to some embodiments of the present disclosure.

FIG. 3B is a flowchart extending from FIG. 3A and further illustrating the method for providing sales and customer services, according to some embodiments of the present disclosure.

FIG. 4 is a diagram showing an example of a method for providing sales and customer services, according to some embodiments of the present disclosure.

FIG. 5 is a diagram showing a second example of a method for providing sales and customer services, according to some embodiments of the present disclosure.

FIG. 6 is a diagram showing a third example of a method for providing sales and customer services, according to some embodiments of the present disclosure.

FIG. 7 is a diagram showing a fourth example of a method for providing sales and customer services, according to some embodiments of the present disclosure.

FIG. 8 is a diagram showing a fifth example of a method for providing sales and customer services, according to some embodiments of the present disclosure.

FIG. 9 is a diagram showing a sixth example of a method for providing sales and customer services, according to some embodiments of the present disclosure.

FIG. 10 is a diagram showing a seventh example of a method for providing sales and customer services, according to some embodiments of the present disclosure.

### DETAILED DESCRIPTION

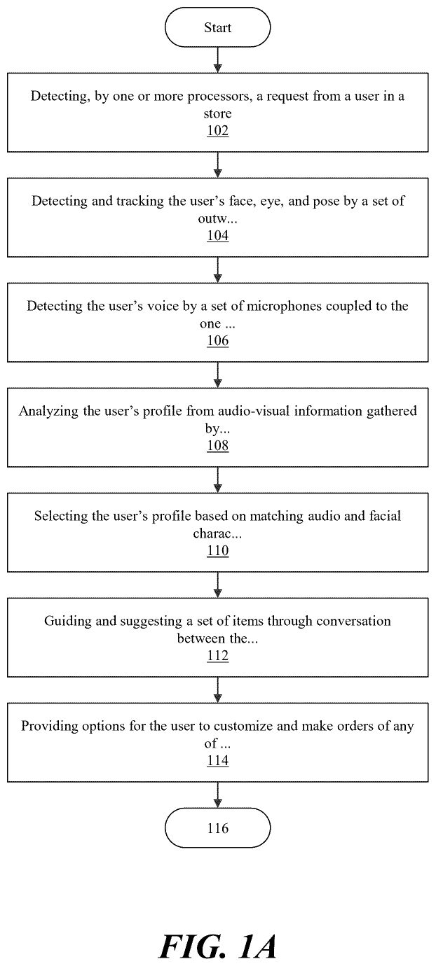

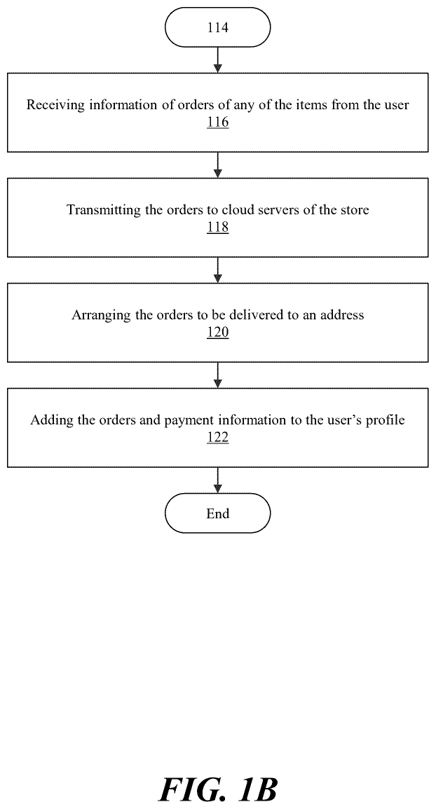

FIGS. 1A to 1B are flowcharts that describe a method for providing sales and customer services, according to some embodiments of the present disclosure. In some embodiments, at 102, the method may include detecting, by one or more processors, a request from a user in a store. At 104, the method may include detecting and tracking the user's face, eye, and pose by a set of outward-facing cameras coupled to the one or more processors. At 106, the method may include detecting the user's voice by a set of microphones coupled to the one or more processors.

In some embodiments, at 108, the method may include analyzing the user's profile from audio-visual information gathered by the set of outward-facing cameras and the set of microphones. At 110, the method may include selecting the user's profile based on matching audio and facial characteristics from a set of profiles in a customer database on the server. At 112, the method may include guiding and suggesting a set of items through conversation between the virtual agents and the user.

In some embodiments, at 114, the method may include providing options for the user to customize and make orders of any of items in the store. At 116, the method may include receiving information of orders of any of the items from the user. At 118, the method may include transmitting the orders to cloud servers of the store. At 120, the method may include arranging the orders to be delivered to an address. At 122, the method may include adding the orders and payment information to the user's profile.

In some embodiments, an artificial intelligence engine may be coupled to the one or more processors and a server. The artificial intelligence engine may be trained by human experts in the field. The virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agents.

In some embodiments, the virtual agents may be configured to be displayed with an appearance of a real human or a humanoid or a cartoon character. The virtual agents' gender, age and ethnicity may be determined by the artificial Intelligence's analysis on input from the user. The virtual agents may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The visual agents may be connected via network means. A set of touch screens coupled to the one or more processors may be configured to allow the user to interact with the virtual agents by hand, facial express, sign language and body posture. The set of microphones may be connected to loudspeakers.

In some embodiments, the set of microphones may be enabled to be beamforming. Pictures or voices of the user may be configured to be uploaded and processed either on a cloud server or in local or personal devices to analyze and create the virtual agents. The virtual agents may be configured to be created based on the appearance of a real human character. The user's profile may include the user's audio and facial characteristics.

In some embodiments, the user's profile may comprise information on prior food ordering habits, food preferences, and possible food allergies. The guiding and the suggestions may be based on the user's profile and analysis of the artificial intelligence engine. The virtual agent may be configured to suggest items that the user may be mostly willing to buy based on interactions between the virtual agents and the user and the analysis of the artificial intelligence engine. The options. Customization of the items, methods of payment or financing, and method of delivery of the items. The information may include information of payment. The user can choose different ways for the payment. The different ways may include usages of credit cards, payment applications, cash, checks, cryptocurrency or other payment means. The address may be chosen by the user.

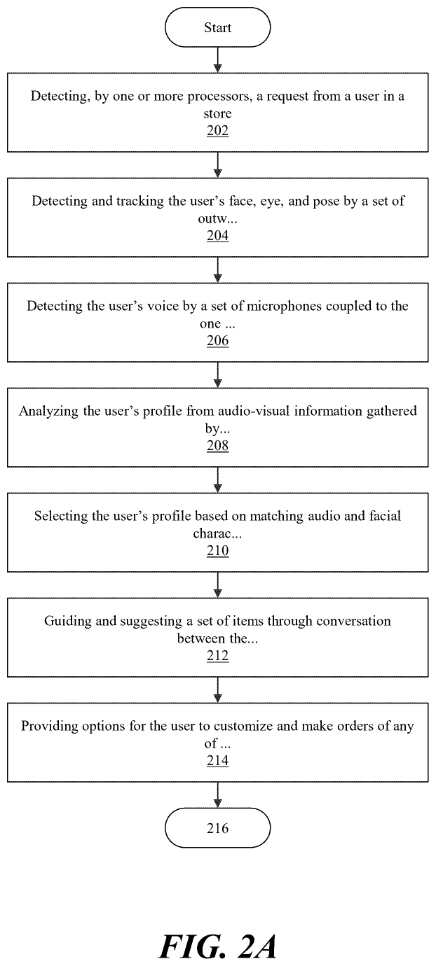

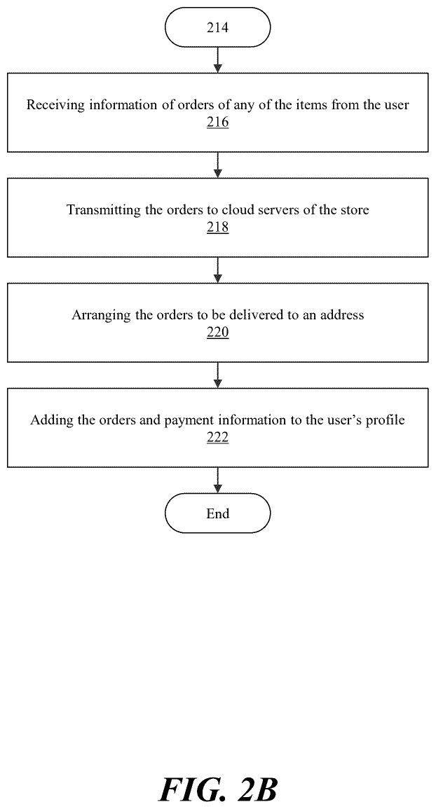

FIGS. 2A to 2B are flowcharts that describe a method for providing sales and customer services, according to some embodiments of the present disclosure. In some embodiments, at 202, the method may include detecting, by one or more processors, a request from a user in a store. At 204, the method may include detecting and tracking the user's face, eye, and pose by a set of outward-facing cameras coupled to the one or more processors. At 206, the method may include detecting the user's voice by a set of microphones coupled to the one or more processors.

In some embodiments, at 208, the method may include analyzing the user's profile from audio-visual information gathered by the set of outward-facing cameras and the set of microphones. At 210, the method may include selecting the user's profile based on matching audio and facial characteristics from a set of profiles in a customer database on the server. At 212, the method may include guiding and suggesting a set of items through conversation between the virtual agents and the user.

In some embodiments, at 214, the method may include providing options for the user to customize and make orders of any of items in the store. At 216, the method may include receiving information of orders of any of the items from the user. At 218, the method may include transmitting the orders to cloud servers of the store. At 220, the method may include arranging the orders to be delivered to an address. At 222, the method may include adding the orders and payment information to the user's profile.

In some embodiments, an artificial intelligence engine may be coupled to the one or more processors and a server. The artificial intelligence engine may be trained by human experts in the field. The virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agents.

In some embodiments, the virtual agents may be configured to be displayed with an appearance of a real human or a humanoid or a cartoon character. The virtual agents' gender, age and ethnicity may be determined by the artificial Intelligence's analysis on input from the user. The virtual agents may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The visual agents may be connected via network means. A set of touch screens coupled to the one or more processors may be configured to allow the user to interact with the virtual agents by hand, facial express, sign language and body posture. The set of microphones may be connected to loudspeakers.

In some embodiments, the set of microphones may be enabled to be beamforming. Pictures or voices of the user may be configured to be uploaded and processed either on a cloud server or in local or personal devices to analyze and create the virtual agents. The virtual agents may be configured to be created based on the appearance of a real human character. The user's profile may include the user's audio and facial characteristics.

In some embodiments, the user's profile may comprise information on prior food ordering habits, food preferences, and possible food allergies. The guiding and the suggestions may be based on the user's profile and analysis of the artificial intelligence engine. The virtual agent may be configured to suggest items that the user may be mostly willing to buy based on interactions between the virtual agents and the user and the analysis of the artificial intelligence engine.

In some embodiments, the options. Customization of the items, methods of payment or financing, and method of delivery of the items. The information may include information of payment. The user can choose different ways for the payment. The different ways may include usages of credit cards, payment applications, cash, checks, cryptocurrency or other payment means. The user also can scan a QR code for certain items for ordering and payment. The address may be chosen by the user.

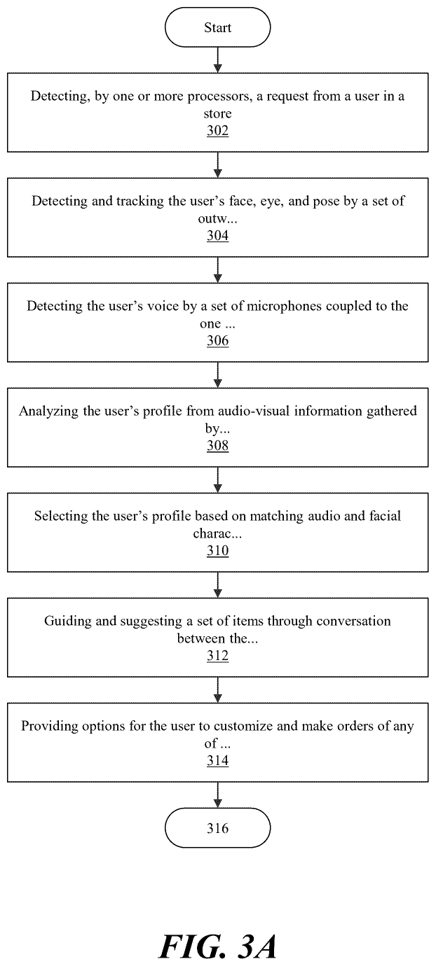

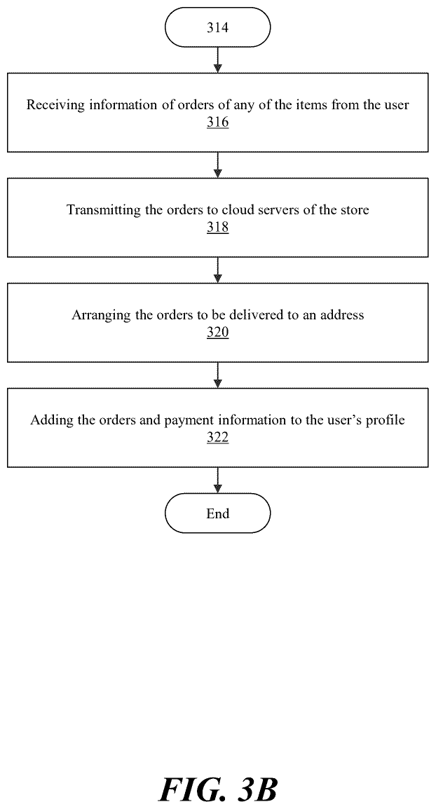

FIGS. 3A to 3B are flowcharts that describe a method for providing sales and customer services, according to some embodiments of the present disclosure. In some embodiments, at 302, the method may include detecting, by one or more processors, a request from a user in a store. At 304, the method may include detecting and tracking the user's face, eye, and pose by a set of outward-facing cameras coupled to the one or more processors. At 306, the method may include detecting the user's voice by a set of microphones coupled to the one or more processors.

In some embodiments, at 308, the method may include analyzing the user's profile from audio-visual information gathered by the set of outward-facing cameras and the set of microphones. At 310, the method may include selecting the user's profile based on matching audio and facial characteristics from a set of profiles in a customer database on the server. At 312, the method may include guiding and suggesting a set of items through conversation between the virtual agents and the user.

In some embodiments, at 314, the method may include providing options for the user to customize and make orders of any of items in the store. At 316, the method may include receiving information of orders of any of the items from the user. At 318, the method may include transmitting the orders to cloud servers of the store. At 320, the method may include arranging the orders to be delivered to an address. At 322, the method may include adding the orders and payment information to the user's profile.

In some embodiments, an artificial intelligence engine may be coupled to the one or more processors and a server. The artificial intelligence engine may be trained by human experts in the field. The virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agents.

In some embodiments, the virtual agents may be configured to be displayed with an appearance of a real human or a humanoid or a cartoon character. The virtual agents' gender, age and ethnicity may be determined by the artificial Intelligence's analysis on input from the user. The virtual agents may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The visual agents may be connected via network means. A set of touch screens coupled to the one or more processors may be configured to allow the user to interact with the virtual agents by hand, facial express, sign language and body posture. The user can be identified by a specific facial ID.

In some embodiments, the set of microphones may be connected to loudspeakers. The set of microphones may be enabled to be beamforming. Pictures or voices of the user may be configured to be uploaded and processed either on a cloud server or in local or personal devices to analyze and create the virtual agents. The virtual agents may be configured to be created based on the appearance of a real human character. The user's profile may include the user's audio and facial characteristics.

In some embodiments, the user's facial ID may be associated with the facial characteristics. The user's profile may comprise information on prior food ordering habits, food preferences, and possible food allergies. The guiding and the suggestions may be based on the user's profile and analysis of the artificial intelligence engine. The virtual agent may be configured to suggest items that the user may be mostly willing to buy based on interactions between the virtual agents and the user and the analysis of the artificial intelligence engine.

In some embodiments, the options. Customization of the items, methods of payment or financing, and method of delivery of the items. The information may include information of payment. The user can choose different ways for the payment. The different ways may include usages of credit cards, payment applications, cash, checks, cryptocurrency or other payment means. The user also can scan a QR code for a certain items for ordering and payment. The address may be chosen by the user.

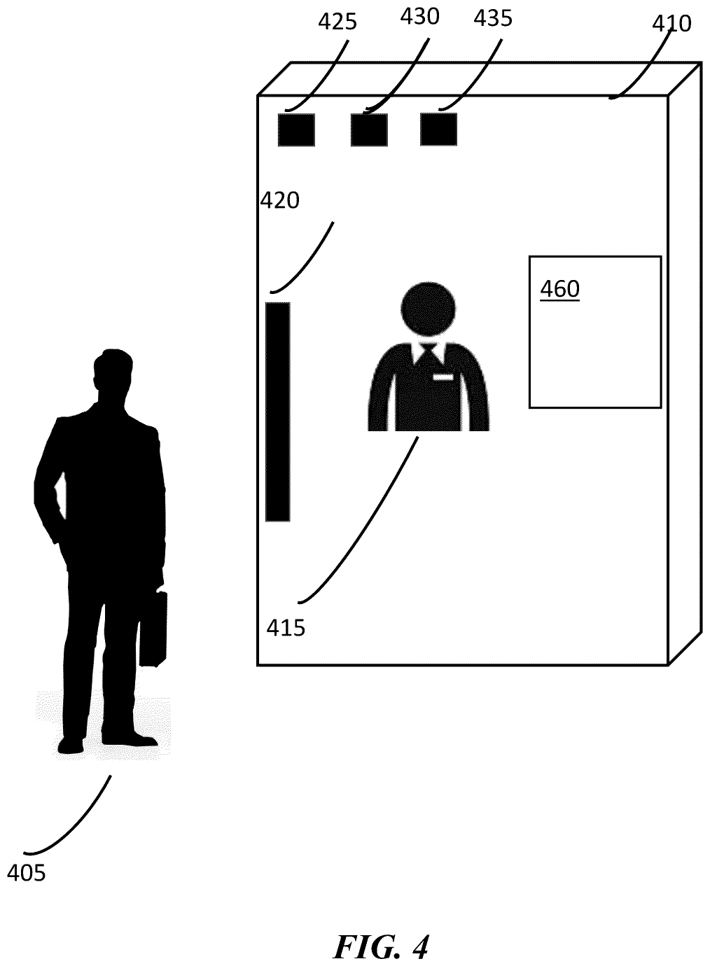

FIG. 4 is a diagram showing an example that describes a first example of a method for providing sales and customer services, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual assistants as described in this example and methods described in FIG. 1-3.

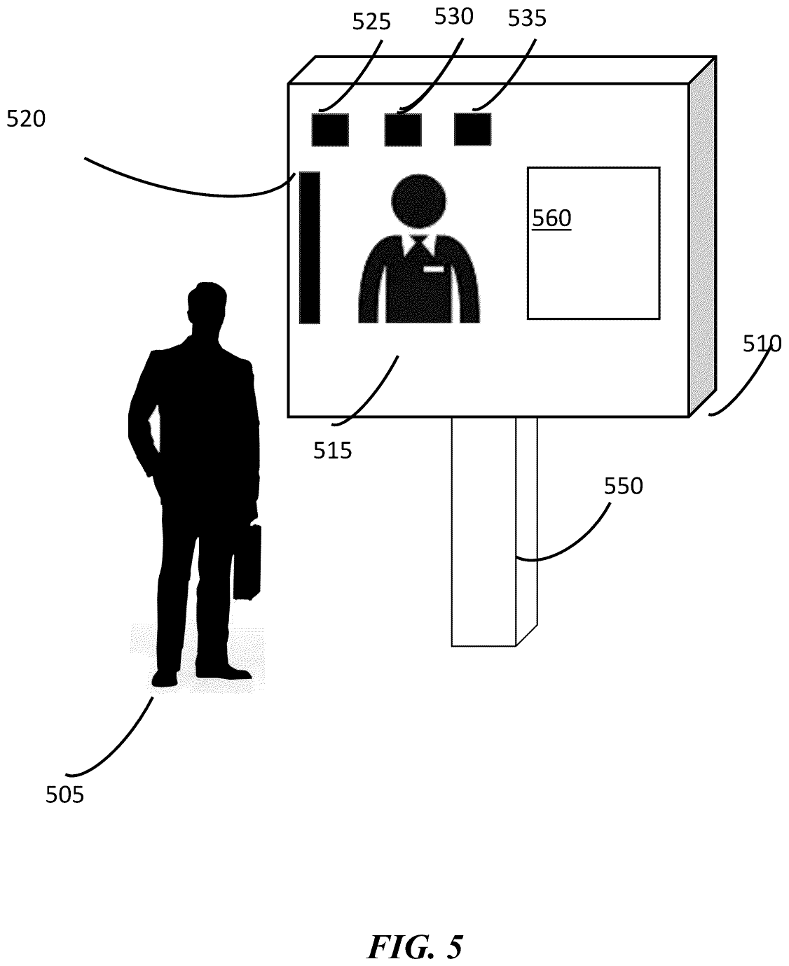

FIG. 5 is a diagram showing a second example of a method for providing sales and customer services, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

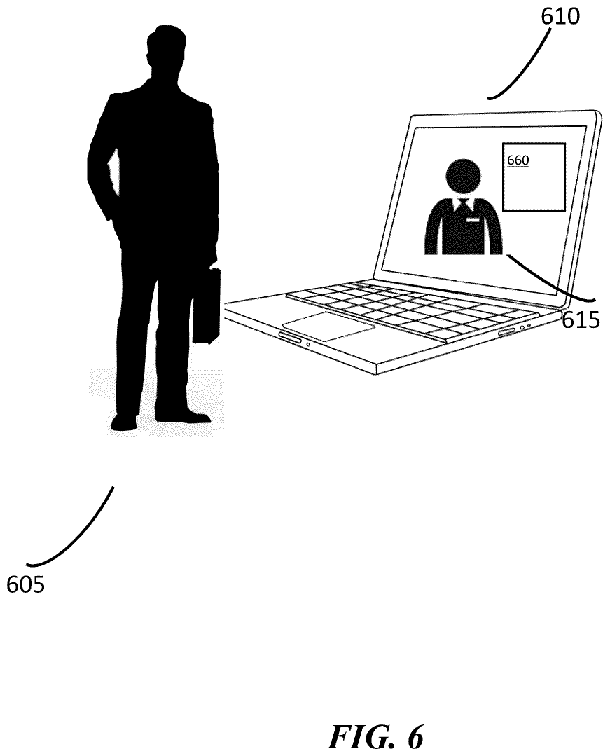

FIG. 6 is a diagram showing a third example of a method for providing sales and customer services, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

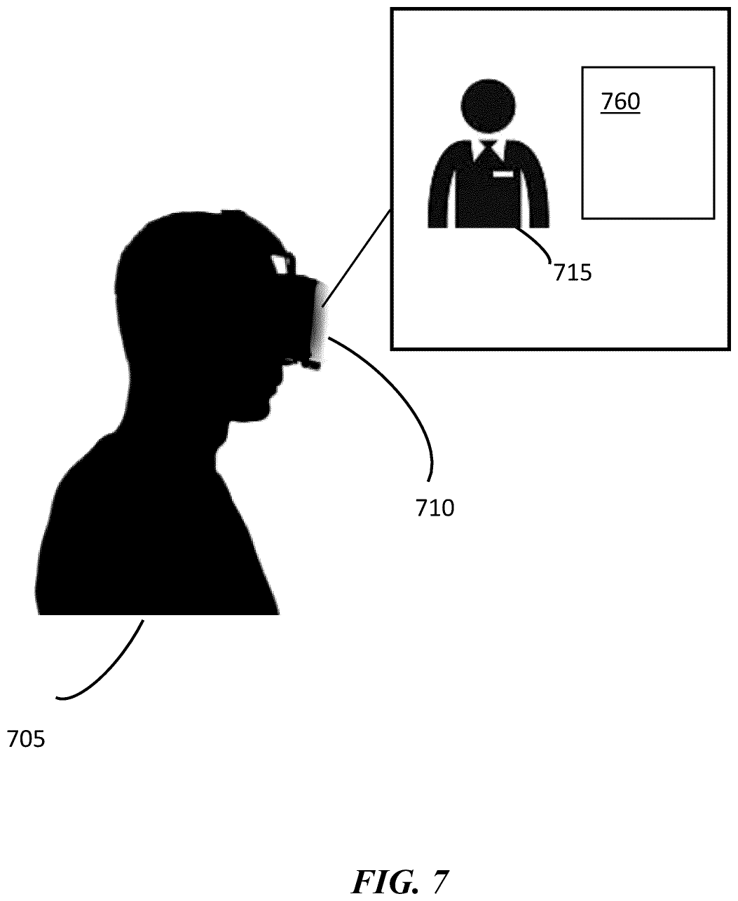

FIG. 7 is a diagram showing a fourth example of a method for providing sales and customer services, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

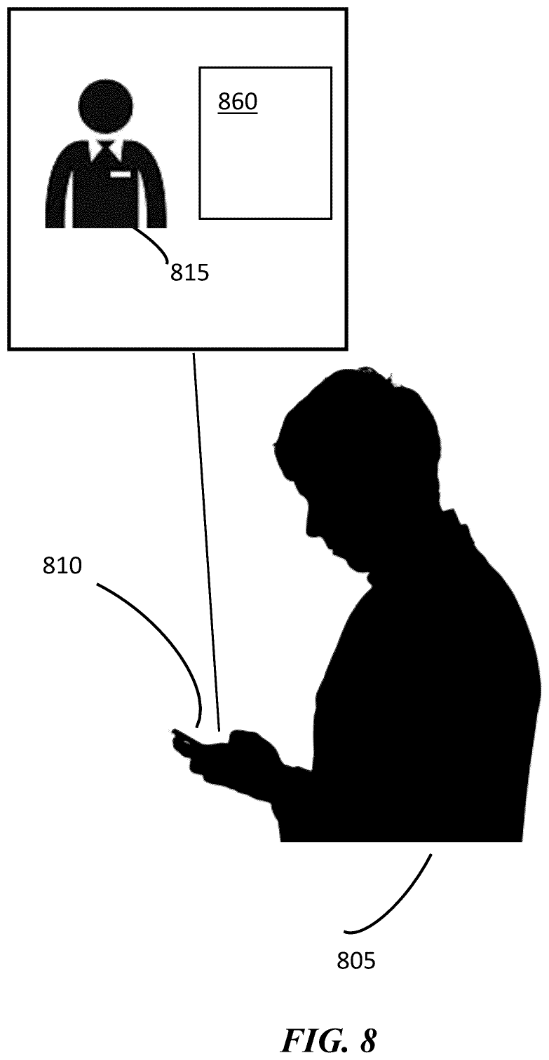

FIG. 8 is a diagram showing a fifth example of a method for providing sales and customer services, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

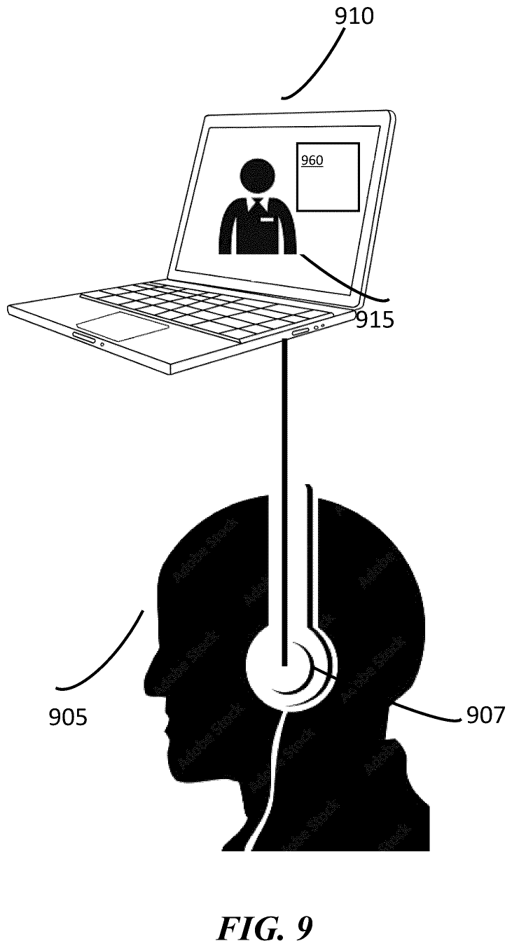

FIG. 9 is a diagram showing a sixth example of a method for providing sales and customer services, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

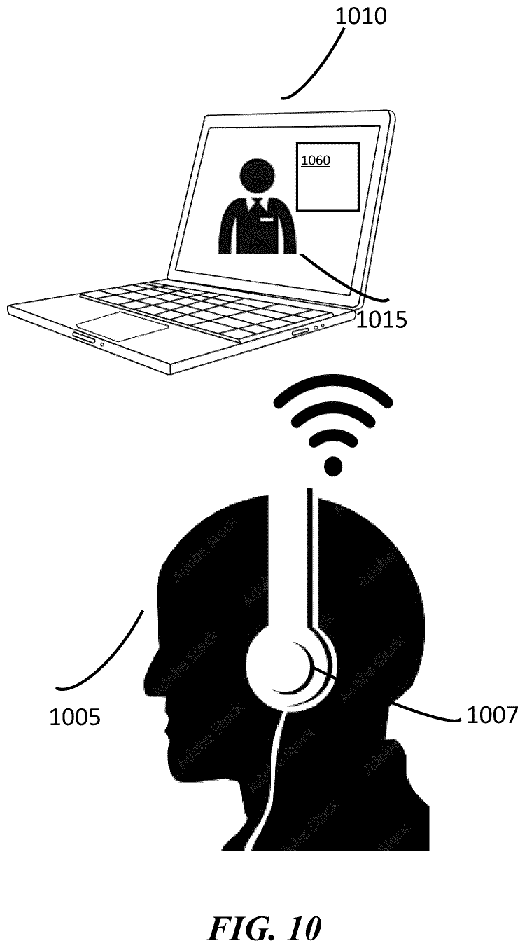

FIG. 10 is a diagram showing a seventh example of a method for providing sales and customer services, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

1. A method for providing sales and customer services via virtual agents powered with artificial intelligence, the method comprising:
detecting, by one or more processors, a request from a user in a store, wherein an artificial intelligence engine is coupled to the one or more processors and a server, wherein the artificial intelligence engine is trained by human experts in the field, wherein the virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agents, wherein the virtual agents are configured to be displayed with an appearance of a real human or a humanoid or a cartoon character, wherein the virtual agents' gender, age and ethnicity is determined by the artificial Intelligence's analysis on input from the user, wherein the virtual agents are configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the visual agents are connected via network means;
detecting and tracking the user's face, eye, and pose by a set of outward-facing cameras coupled to the one or more processors, wherein a set of touch screens coupled to the one or more processors is configured to allow the user to interact with the virtual agents by hand, facial express, sign language and body posture;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agents, wherein the virtual agents are configured to be created based on the appearance of a real human character;
analyzing the user's profile from audio-visual information gathered by the set of outward-facing cameras and the set of microphones, wherein the user's profile includes the user's audio and facial characteristics;
selecting the user's profile based on matching audio and facial characteristics from a set of profiles in a customer database on the server, wherein the user's profile comprises information on prior food ordering habits, food preferences, and possible food allergies;
guiding and suggesting a set of items through conversation between the virtual agents and the user, wherein the guiding and the suggestions are based on the user's profile and analysis of the artificial intelligence engine, wherein the virtual agent is configured to suggest items that the user is mostly willing to buy based on interactions between the virtual agents and the user and the analysis of the artificial intelligence engine;
providing options for the user to customize and make orders of any of items in the store, wherein the options comprise customization of the items, methods of payment or financing, and method of delivery of the items;
receiving information of orders of any of the items from the user, wherein the information includes information of payment, wherein the user can choose different ways for the payment, wherein the different ways includes usages of credit cards, payment applications, cash, checks, cryptocurrency or other payment means;
transmitting the orders to cloud servers of the store;
arranging the orders to be delivered to an address, wherein the address is chosen by the user; and
adding the orders and payment information to the user's profile.

2. A method for providing sales and customer services via virtual agents powered with artificial intelligence, the method comprising:
detecting, by one or more processors, a request from a user in a store, wherein an artificial intelligence engine is coupled to the one or more processors and a server, wherein the artificial intelligence engine is trained by human experts in the field, wherein the virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agents, wherein the virtual agents are configured to be displayed with an appearance of a real human or a humanoid or a cartoon character, wherein the virtual agents' gender, age and ethnicity is determined by the artificial Intelligence's analysis on input from the user, wherein the virtual agents are configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the visual agents are connected via network means;
detecting and tracking the user's face, eye, and pose by a set of outward-facing cameras coupled to the one or more processors, wherein a set of touch screens coupled to the one or more processors is configured to allow the user to interact with the virtual agents by hand, facial express, sign language and body posture;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agents, wherein the virtual agents are configured to be created based on the appearance of a real human character;
analyzing the user's profile from audio-visual information gathered by the set of outward-facing cameras and the set of microphones, wherein the user's profile includes the user's audio and facial characteristics;
selecting the user's profile based on matching audio and facial characteristics from a set of profiles in a customer database on the server, wherein the user's profile comprises information on prior food ordering habits, food preferences, and possible food allergies;
guiding and suggesting a set of items through conversation between the virtual agents and the user, wherein the guiding and the suggestions are based on the user's profile and analysis of the artificial intelligence engine, wherein the virtual agent is configured to suggest items that the user is mostly willing to buy based on interactions between the virtual agents and the user and the analysis of the artificial intelligence engine;
providing options for the user to customize and make orders of any of items in the store, wherein the options comprise customization of the items, methods of payment or financing, and method of delivery of the items;
receiving information of orders of any of the items from the user, wherein the information includes information of payment, wherein the user can choose different ways for the payment, wherein the different ways include usages of credit cards, payment applications, cash, checks, cryptocurrency or other payment means, wherein the user also can scan a QR code for certain items for ordering and payment;
transmitting the orders to cloud servers of the store;
arranging the orders to be delivered to an address, wherein the address is chosen by the user; and
adding the orders and payment information to the user's profile.

3. A method for providing sales and customer services via virtual agents powered with artificial intelligence, the method comprising:
detecting, by one or more processors, a request from a user in a store, wherein an artificial intelligence engine is coupled to the one or more processors and a server, wherein the artificial intelligence engine is trained by human experts in the field, wherein the virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agents, wherein the virtual agents are configured to be displayed with an appearance of a real human or a humanoid or a cartoon character, wherein the virtual agents' gender, age and ethnicity is determined by the artificial Intelligence's analysis on input from the user, wherein the virtual agents are configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the visual agents are connected via network means;
detecting and tracking the user's face, eye, and pose by a set of outward-facing cameras coupled to the one or more processors, wherein a set of touch screens coupled to the one or more processors is configured to allow the user to interact with the virtual agents by hand, facial express, sign language and body posture, wherein the user can be identified by a specific facial ID;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agents, wherein the virtual agents are configured to be created based on the appearance of a real human character;
analyzing the user's profile from audio-visual information gathered by the set of outward-facing cameras and the set of microphones, wherein the user's profile includes the user's audio and facial characteristics, wherein the user's facial ID is associated with the facial characteristics;
selecting the user's profile based on matching audio and facial characteristics from a set of profiles in a customer database on the server, wherein the user's profile comprises information on prior food ordering habits, food preferences, and possible food allergies;
guiding and suggesting a set of items through conversation between the virtual agents and the user, wherein the guiding and the suggestions are based on the user's profile and analysis of the artificial intelligence engine, wherein the virtual agent is configured to suggest items that the user is mostly willing to buy based on interactions between the virtual agents and the user and the analysis of the artificial intelligence engine;
providing options for the user to customize and make orders of any of items in the store, wherein the options comprise customization of the items, methods of payment or financing, and method of delivery of the items;
receiving information of orders of any of the items from the user, wherein the information includes information of payment, wherein the user can choose different ways for the payment, wherein the different ways include usages of credit cards, payment applications, cash, checks, cryptocurrency or other payment means, wherein the user also can scan a QR code for a certain items for ordering and payment;
transmitting the orders to cloud servers of the store;
arranging the orders to be delivered to an address, wherein the address is chosen by the user; and
adding the orders and payment information to the user's profile.
